(19) United States
(12) Patent Application Publication
(10) Pub. No.: US 2019/0116513 A1
(43) Pub. Date: Apr. 18, 2019

(54) EXTREMELY HIGH THROUGHPUT (EHT) SIGNAL DETECTION

(71) Applicant: QUALCOMM Incorporated, San Diego, CA (US)

(72) Inventors: Lochan Verma, San Diego, CA (US); Bin Tian, San Diego, CA (US); Sameer Vermani, San Diego, CA (US); Lin Yang, San Diego, CA (US); Jialing Li Chen, San Diego, CA (US)

(21) Appl. No.: 16/160,909

(22) Filed: Oct. 15, 2018

Related U.S. Application Data
(60) Provisional application No. 62/573,138, filed on Oct. 16, 2017.

(51) Int. Cl. H04W 24/08; H04W 72/04

(52) U.S. Cl. CPC H04W 24/08; H04W 72/0453

(57) ABSTRACT

Methods, systems, and devices for wireless communications are described. An access point (AP) may configure a preamble for a wireless transmission to include information indicative of a corresponding extremely high throughput (EHT) packet. In some cases, the preamble may be configured to include a signaling field indicative of the EHT packet. In some cases, symbols or bits of the preamble may be configured to indicate the EHT packet. In yet other cases, a field of the packet may be masked to indicate the EHT packet. A wireless station (STA) may receive the configured preamble, and based on the preamble, may receive (e.g., decode) the EHT packet.

### CROSS REFERENCES

The present Application for Patent claims priority to U.S. Provisional Patent Application No. 62/573,138 by Verma, et al., entitled “ULTRA HIGH THROUGHPUT (UHT) SIGNAL DETECTION AND UHT SIGNALING FIELDS IN A PREAMBLE,” filed Oct. 16, 2017, assigned to the assignee hereof, and which is hereby expressly incorporated by reference herein in its entirety.

### BACKGROUND

The following relates generally to wireless communications, and more specifically to extremely high throughput (EHT) signal detection.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform-spread-OFDM (DFT-S-OFDM). A wireless multiple-access communications system may include a number of base stations or network access nodes, each simultaneously supporting communication for multiple communication devices, which may be otherwise known as user equipment (UE).

A wireless local area network (WLAN) may be formed by one or more access points (APs) that provide a shared wireless communication medium for use by a number of client devices also referred to as stations (STAs). The basic building block of a WLAN conforming to the 802.11 family of standards is a Basic Service Set (BSS), which is managed by an AP. Each BSS is identified by a service set identifier (SSID) that is advertised by the AP. An AP periodically broadcasts beacon frames to enable any STAs within wireless range of the AP to establish and/or maintain a communication link with the WLAN. In a typical WLAN, each STA may be associated with only one AP at a time. To identify an AP with which to associate, a STA is configured to perform scans on the wireless channels of each of one or more frequency bands (for example, the 2.4 GHz band and/or the 5 GHz band). As a result of the increasing ubiquity of wireless networks, a STA may have the opportunity to select one of many WLANs within range of the STA and/or select among multiple APs that together form an extended BSS. After association with an AP, a STA also may be configured to periodically scan its surroundings to find a more suitable AP with which to associate. For example, a STA that is moving relative to its associated AP may perform a “roaming” scan to find an AP having more desirable network characteristics such as a greater received signal strength indicator (RSSI).

Wireless communications systems are widely deployed to provide various types of communication content such as voice, video, packet data, messaging, broadcast, and so on. These systems may be multiple-access systems capable of supporting communication with multiple users by sharing the available system resources (for example, time, frequency, and space). The AP may be coupled to a network, such as the Internet, and may enable a station to communicate via the network including communicating with other devices coupled to the AP.

It is contemplated that next generation Wi-Fi, beyond 802.11ax, will have, among other features, a larger channel bandwidth, higher order modulation, a larger number of spatial streams and possible operation in 2.4 GHz, 5 GHz, and 6 GHz unlicensed spectrum. This next generation WiFi is referred to as EHT communications. There remains a need for techniques for EHT signaling fields in a preamble for use in Wireless Local Area Networks (WLAN).

### SUMMARY

The described techniques relate to improved methods, systems, devices, and apparatuses that support extremely high throughput (EHT) communication detection. Generally, the described techniques provide for signaling in a preamble of a wireless communication indicative of an EHT packet. A wireless communications system may include an access point (AP) and at least one wireless station (STA). The AP may determine that a wireless communication scheduled to be transmitted to the STA include an EHT packet, which may meet certain, stringent throughput thresholds. The AP may configure a preamble of the wireless communication to indicate that a packet of the wireless communication includes an EHT packet. In some cases, the AP may configure reserved bits in the preamble to indicate an EHT packet. In some other cases, the AP may configure a high efficiency (HE) field of a preamble to indicate the EHT packet. In yet other cases, the AP may configure a signaling field to indicate the EHT packet. Accordingly, the wireless communication preamble may allow for the STA to successfully receive and decode an EHT communication.

A method of wireless communications is described. The method may include receiving a preamble of a wireless transmission, the preamble including a legacy preamble portion and a HE preamble portion, determining, based on a set of one or more reserved bits in a HE signaling field of the HE preamble portion, that the wireless transmission includes an EHT packet, setting, based on the determination, a receive parameter for the EHT packet of the wireless transmission, the receive parameter including one or more of: a channel bandwidth, a spatial stream setting, or a modulation order, and receiving the EHT packet of the wireless transmission based on the determination and according to the receive parameter.

An apparatus for wireless communications is described. The apparatus may include a processor, memory in electronic communication with the processor, and instructions stored in the memory. The instructions may be executable by the processor to cause the apparatus to receive a preamble of a wireless transmission, the preamble including a legacy preamble portion and a HE preamble portion, determine, based on a set of one or more reserved bits in a HE signaling field of the HE preamble portion, that the wireless transmission includes an EHT packet, set, based on the determination, a receive parameter for the EHT packet of the wireless transmission, the receive parameter including one or more of: a channel bandwidth, a spatial stream setting, or a modulation order, and receive the EHT packet of the wireless transmission based on the determination and according to the receive parameter.

Another apparatus for wireless communications is described. The apparatus may include means for receiving a preamble of a wireless transmission, the preamble including a legacy preamble portion and a HE preamble portion, determining, based on a set of one or more reserved bits in a HE signaling field of the HE preamble portion, that the wireless transmission includes an EHT packet, setting, based on the determination, a receive parameter for the EHT packet of the wireless transmission, the receive parameter including one or more of: a channel bandwidth, a spatial stream setting, or a modulation order, and receiving the EHT packet of the wireless transmission based on the determination and according to the receive parameter.

A non-transitory computer-readable medium storing code for wireless communications is described. The code may include instructions executable by a processor to receive a preamble of a wireless transmission, the preamble including a legacy preamble portion and a HE preamble portion, determine, based on a set of one or more reserved bits in a HE signaling field of the HE preamble portion, that the wireless transmission includes an EHT packet, set, based on the determination, a receive parameter for the EHT packet of the wireless transmission, the receive parameter including one or more of: a channel bandwidth, a spatial stream setting, or a modulation order, and receive the EHT packet of the wireless transmission based on the determination and according to the receive parameter.

In some examples of the method, apparatuses, and non-transitory computer-readable medium described herein, the HE signaling field of the preamble portion includes a HE SIG-A field. Some examples of the method, apparatuses, and non-transitory computer-readable medium described herein may further include operations, features, means, or instructions for determining an EHT single user physical protocol data unit (SU PPDU) format for the EHT packet based on a value of a fourteenth bit of a SIG-A1 field or a SIG-A2 field; where receiving the EHT packet may be based on the EHT SU PPDU format.

Some examples of the method, apparatuses, and non-transitory computer-readable medium described herein may further include operations, features, means, or instructions for determining an EHT extended range single user physical protocol data unit (ER SU PPDU) format for the EHT packet based on a value of a fourteenth bit of a SIG-A1 field or a SIG-A2 field; where receiving the EHT packet may be based on the EHT ER SU PPDU format.

Some examples of the method, apparatuses, and non-transitory computer-readable medium described herein may further include operations, features, means, or instructions for determining an EHT multi user physical protocol data unit (MU PPDU) format for the EHT packet based on a value of a seventh bit of a SIG-A2 field; where receiving the EHT packet may be based on the EHT MU PPDU format.

Some examples of the method, apparatuses, and non-transitory computer-readable medium described herein may further include operations, features, means, or instructions for determining an EHT trigger based physical protocol data unit (TB PPDU) format for the EHT packet based on a value of a twenty third bit of a SIG-A1 field; where receiving the EHT packet may be based on the EHT TB PPDU format.

Some examples of the method, apparatuses, and non-transitory computer-readable medium described herein may further include operations, features, means, or instructions for receiving a bandwidth field in the preamble, where the bandwidth field includes at least one reconfigured bit from a dual subcarrier modulation (DCM) field, a Space-Time Block Coding (STBC) field, or a Coding field.

In some examples of the method, apparatuses, and non-transitory computer-readable medium described herein, the bandwidth field includes a most significant bit and a least significant bit from discontiguous portions of the preamble.

In some examples of the method, apparatuses, and non-transitory computer-readable medium described herein, the reconfigured bit indicates whether a 320 MHz bandwidth may be employed for the wireless transmission.

Some examples of the method, apparatuses, and non-transitory computer-readable medium described herein may further include operations, features, means, or instructions for receiving a number of streams (Nsts) field in the preamble, where the Nsts field includes at least one reconfigured bit from a dual subcarrier modulation (DCM) field, a Space-Time Block Coding (STBC) field, or a Coding field.

In some examples of the method, apparatuses, and non-transitory computer-readable medium described herein, the Nsts field includes a most significant bit and a least significant bit from discontiguous portions of the preamble.

In some examples of the method, apparatuses, and non-transitory computer-readable medium described herein, the Nsts field indicates a number of transmission streams for the wireless transmission.

Some examples of the method, apparatuses, and non-transitory computer-readable medium described herein may further include operations, features, means, or instructions for receiving a HE signal A (HE SIG-A) field in the HE preamble portion, determining, based on the HE SIG-A field, a bandwidth for the wireless transmission and receiving a HE signal B (HE Sig-B) field in the HE preamble portion; where the HE SIG-B field may be received over 4 content channels.

In some examples of the method, apparatuses, and non-transitory computer-readable medium described herein, the 4 content channels follow a sequential transmission structure.

A method of wireless communications is described. The method may include receiving a preamble of a wireless transmission, the preamble including a legacy preamble portion and a HE preamble portion, determining the HE preamble portion is a masked version of the legacy preamble portion, setting, based on the determination, a receive parameter for the EHT packet of the wireless transmission, the receive parameter including one or more of: a channel bandwidth, a spatial stream setting, or a modulation order, and receiving the EHT packet of the wireless transmission based on the determination and according to the receive parameter.

An apparatus for wireless communications is described. The apparatus may include a processor, memory in electronic communication with the processor, and instructions stored in the memory. The instructions may be executable by the processor to cause the apparatus to receive a preamble of a wireless transmission, the preamble including a legacy preamble portion and a HE preamble portion, determine the HE preamble portion is a masked version of the legacy preamble portion, set, based on the determination, a receive parameter for the EHT packet of the wireless transmission, the receive parameter including one or more of: a channel bandwidth, a spatial stream setting, or a modulation order, and receive the EHT packet of the wireless transmission based on the determination and according to the receive parameter.

Another apparatus for wireless communications is described. The apparatus may include means for receiving a preamble of a wireless transmission, the preamble including a legacy preamble portion and a HE preamble portion, determining the HE preamble portion is a masked version of the legacy preamble portion, setting, based on the determination, a receive parameter for the EHT packet of the wireless transmission, the receive parameter including one or more of: a channel bandwidth, a spatial stream setting, or a modulation order, and receiving the EHT packet of the wireless transmission based on the determination and according to the receive parameter.

A non-transitory computer-readable medium storing code for wireless communications is described. The code may include instructions executable by a processor to receive a preamble of a wireless transmission, the preamble including a legacy preamble portion and a HE preamble portion, determine the HE preamble portion is a masked version of the legacy preamble portion, set, based on the determination, a receive parameter for the EHT packet of the wireless transmission, the receive parameter including one or more of: a channel bandwidth, a spatial stream setting, or a modulation order, and receive the EHT packet of the wireless transmission based on the determination and according to the receive parameter. In some examples of the method, apparatuses, and non-transitory computer-readable medium described herein, the legacy preamble portion includes a legacy signaling (L-SIG) field.

Some examples of the method, apparatuses, and non-transitory computer-readable medium described herein may further include operations, features, means, or instructions for determining a waveform for the L-SIG and a waveform for the HE preamble portion and identifying the HE preamble portion waveform may be a masked version of the L-SIG waveform. In some examples of the method, apparatuses, and non-transitory computer-readable medium described herein, the masked version includes an inverted version of the L-SIG waveform.

Some examples of the method, apparatuses, and non-transitory computer-readable medium described herein may further include operations, features, means, or instructions for receiving a HE signal A (HE SIG-A) field in the HE preamble portion, determining, based on the HE SIG-A field, a bandwidth for the wireless transmission and receiving a HE signal B (HE Sig-B) field in the HE preamble portion; where the HE SIG-B field may be received over 4 content channels. In some examples of the method, apparatuses, and non-transitory computer-readable medium described herein, the 4 content channels follow a sequential transmission structure.

### BRIEF DESCRIPTION OF THE DRAWINGS

FIG. 1 illustrates an example of a system for wireless communications that supports extremely high throughput (EHT) signal detection in accordance with aspects of the present disclosure.

FIG. 2 illustrates examples of EHT frames that support EHT signal detection in accordance with aspects of the present disclosure.

FIG. 3A & 3B illustrate examples of content channel mappings that support EHT signal detection in accordance with aspects of the present disclosure.

FIGS. 4 and 5 show block diagrams of devices that support EHT signal detection in accordance with aspects of the present disclosure.

FIG. 6 shows a block diagram of a communications manager that supports EHT signal detection in accordance with aspects of the present disclosure.

FIG. 7 shows a diagram of a system including a device that supports EHT signal detection in accordance with aspects of the present disclosure.

FIGS. 8 through 11 show flowcharts illustrating methods that support EHT signal detection in accordance with aspects of the present disclosure.

### DETAILED DESCRIPTION

The described techniques relate to improved methods, systems, devices, and apparatuses that support extremely high throughput (EHT) signal detection for wireless communications. Generally, the described techniques provide for use of a wireless communication preamble to indicate an EHT packet. These wireless communication preambles as described herein may provide for efficient signaling for wireless station (STA) detection of EHT communications.

Some wireless communications may require extremely high throughput characteristics for communications within the system. For example, some wireless communication systems may employ EHT communications, which may include large channel bandwidth (e.g., 320 MHz), high modulation (e.g., 4k.16-QAM), a large number of spatial streams (e.g., 16), and/or a high frequency spectrum (e.g., 6 around the GHz range). In some cases, EHT may also refer to Next Generation WiFi, ultra-high throughput (UHT), or very high efficiency (VHE) communications. These characteristics may allow for higher throughput as compared to conventional wireless communications systems.

Conventional wireless communications, however, may not provide for methods of informing receiving STAs that a scheduled communication is an EHT transmission. As such, a STA may fail to successfully receive the EHT transmission, either though failing to detect the EHT transmission or by failing to successfully decode the EHT transmission.

According to techniques described herein, some wireless communications systems may support EHT communication detection in a wireless communication preamble. The preamble may include information corresponding to a subsequent wireless communication packet carrying data for the STA. The preamble may indicate, by one or more symbols or fields in the preamble, that the corresponding wireless communication packet includes an EHT transmission (e.g., exhibits characteristics of EHT transmissions as discussed above). The STA may thus anticipate the reception of an EHT transmission, and may successfully decode the EHT packet accordingly.

Aspects of the disclosure are initially described in the context of a wireless communications system. Aspects of the disclosure are further illustrated by and described with reference to apparatus diagrams, system diagrams, and flowcharts that relate to EHT signal detection.

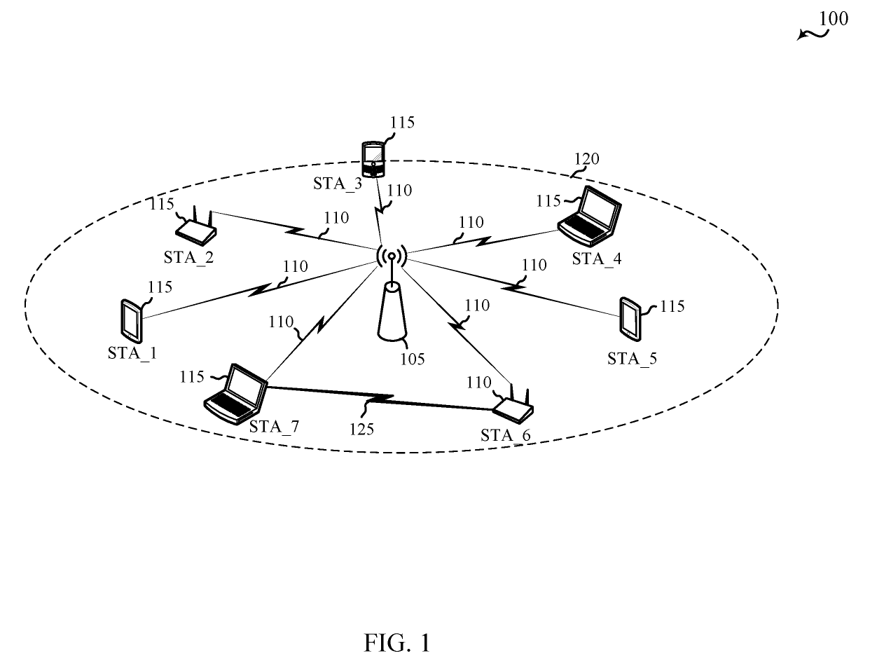

FIG. 1 a block diagram of an example of a wireless local area network (WLAN) (and will hereinafter be referred to as WLAN 100). For example, the WLAN 100 can be a network implementing at least one of the IEEE 802.11 family of standards. The WLAN 100 may include numerous wireless devices such as an access point (AP) 105 and multiple associated STAs 115. Each of the STAs 115 also may be referred to as a mobile station (MS), a mobile device, a mobile handset, a wireless handset, an access terminal (AT), a user equipment (UE), a subscriber station (SS), or a subscriber unit, among other possibilities. The STAs 115 may represent various devices such as mobile phones, personal digital assistant (PDAs), other handheld devices, netbooks, notebook computers, tablet computers, laptops, display devices (for example, TVs, computer monitors, navigation systems, among others), printers, key fobs (for example, for passive keyless entry and start (PKES) systems), among other possibilities.

Each of the STAs 115 may associate and communicate with the AP 105 via a communication link 110. The various STAs 115 in the network are able to communicate with one another through the AP 105. A single AP 105 and an associated set of STAs 115 may be referred to as a basic service set (BSS). FIG. 1 additionally shows an example coverage area 120 of the AP 105, which may represent a basic service area (BSA) of the WLAN 100. While only one AP 105 is shown, the WLAN 100 can include multiple APs 105. An extended service set (ESS) may include a set of connected BSSs. An extended network station associated with the WLAN 100 may be connected to a wired or wireless distribution system that may allow multiple APs 105 to be connected in such an ESS. As such, a STA 115 can be covered by more than one AP 105 and can associate with different APs 105 at different times for different transmissions.

STAs 115 may function and communicate (via the respective communication links 110) according to the IEEE 802.11 family of standards and amendments including, but not limited to, 802.11a, 802.11b, 802.11g, 802.11n, 802.11ac, 802.11ad, 802.11ah, 802.11ay, 802.11ax, 802.11az, and 802.11ba. These standards define the WLAN radio and baseband protocols for the PHY and medium access control (MAC) layers. The wireless devices in the WLAN 100 may communicate over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. The unlicensed spectrum may also include other frequency bands, such as the emerging 6 GHz band. The wireless devices in the WLAN 100 also can be configured to communicate over other frequency bands such as shared licensed frequency bands, where multiple operators may have a license to operate in the same or overlapping frequency band or bands.

In some cases, STAs 115 may form networks without APs 105 or other equipment other than the STAs 115 themselves. One example of such a network is an ad hoc network (or wireless ad hoc network). Ad hoc networks may alternatively be referred to as mesh networks or peer-to-peer (P2P) connections. In some cases, ad hoc networks may be implemented within a larger wireless network such as the WLAN 100. In such implementations, while the STAs 115 may be capable of communicating with each other through the AP 105 using communication links 110, STAs 115 also can communicate directly with each other via direct wireless communication links 125. Additionally, two STAs 115 may communicate via a direct wireless communication link 125 regardless of whether both STAs 115 are associated with and served by the same AP 105. In such an ad hoc system, one or more of the STAs 115 may assume the role filled by the AP 105 in a BSS. Such a STA 115 may be referred to as a group owner (GO) and may coordinate transmissions within the ad hoc network. Examples of direct wireless communication links 125 include Wi-Fi Direct connections, connections established by using a Wi-Fi Tunneled Direct Link Setup (TDLS) link, and other peer-to-peer (P2P) group connections.

Some types of STAs 115 may provide for automated communication. Automated wireless devices may include those implementing internet-of-things (IoT) communication, Machine-to-Machine (M2M) communication, or machine type communication (MTC). IoT, M2M or MTC may refer to data communication technologies that allow devices to communicate without human intervention. For example, IoT, M2M or MTC may refer to communications from STAs 115 that integrate sensors or meters to measure or capture information and relay that information to a central server or application program that can make use of the information or present the information to humans interacting with the program or application.

Some of STAs 115 may be MTC devices, such as MTC devices designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. An MTC device may operate using half-duplex (one-way) communications at a reduced peak rate. MTC devices may also be configured to enter a power saving “deep sleep” mode when not engaging in active communications.

WLAN 100 may support beamformed transmissions. As an example, AP 105 may use multiple antennas or antenna arrays to conduct beamforming operations for directional communications with a STA 115. Beamforming (which may also be referred to as spatial filtering or directional transmission) is a signal processing technique that may be used at a transmitter (e.g., AP 105) to shape and/or steer an overall antenna beam in the direction of a target receiver (e.g., a STA 115). Beamforming may be achieved by combining elements in an antenna array in such a way that transmitted signals at particular angles experience constructive interference while others experience destructive interference. In some cases, the ways in which the elements of the antenna array are combined at the transmitter may depend on channel state information (CSI) associated with the channels over which the AP 105 may communicate with the STA 115. That is, based on this CSI, the AP 105 may appropriately weight the transmissions from each antenna (e.g., or antenna port) such that the desired beamforming effects are achieved. In some cases, these weights may be determined before beamforming can be employed. For example, the transmitter (e.g., the AP 105) may transmit one or more sounding packets to the receiver in order to determine CSI.

WLAN 100 may further support multiple-input, multiple-output (MIMO) wireless systems. Such systems may use a transmission scheme between a transmitter (e.g., AP 105) and a receiver (e.g., a STA 115), where both transmitter and receiver are equipped with multiple antennas. For example, AP 105 may have an antenna array with a number of rows and columns of antenna ports that the AP 105 may use for beamforming in its communication with a STA 115. Signals may be transmitted multiple times in different directions (e.g., each transmission may be beamformed differently). The receiver (e.g., STA 115) may try multiple beams (e.g., antenna subarrays) while receiving the signals.

WLAN protocol data units (PDUs) may be transmitted over a radio frequency spectrum band, which in some examples may include multiple sub-bands or frequency channels. In some cases, the radio frequency spectrum band may have a bandwidth of 80 MHz, and each of the sub-bands or channels may have a bandwidth of 20 MHz. Transmissions to and from STAs 115 and APs 105 typically include control information within a header that is transmitted prior to data transmissions. The information provided in a header is used by a receiving device to decode the subsequent data. A legacy WLAN preamble may include legacy short training field (STF) (L-STF) information, legacy long training field (LTF) (L-LTF) information, and legacy signaling (L-SIG) information. The legacy preamble may be used for packet detection, automatic gain control and channel estimation, among other uses. The legacy preamble may also be used to maintain compatibility with legacy devices.

In some cases, aspects of transmissions may vary based on a distance between a transmitter (for example, AP 105) and a receiver (for example, STA 115). WLAN 100 may otherwise generally benefit from AP 105 having information regarding the location of the various STAs 115 within coverage area 120. In some examples, relevant distances may be computed using round-trip time (RTT) based ranging procedures. As an example, WLAN 100 may offer such functionality that produces accuracy on the order of one meter (or even centimeter-level accuracy). The same (or similar) techniques employed in WLAN 100 may be applied across other radio access technologies (RATs). For example, such RTT-based ranging functionality may be employed in developing “relative geofencing” applications (i.e., applications where there is a geofence relative to an object of interest such as a mobile device, a car, a person, etc.). Various such examples are considered in accordance with aspects of the present disclosure. For example, car keys may employ RTT estimation for Passive Keyless Entry and Start (PKES) systems. RTT-based geofences around an adult may monitor the position of a child within the geofence. Additionally, drone-to-drone and car-to-car RTT functionality may help prevent collisions.

An AP 105 may configure a preamble for a wireless transmission to include information indicative of a corresponding EHT packet. In some cases, the preamble may be configured to include a signaling field indicative of the EHT packet. In some cases, symbols or bits of the preamble may be configured to indicate the EHT packet. In yet other cases, a field of the packet may be masked to indicate the EHT packet. A STA may receive the configured preamble, and based on the preamble, may receive (e.g., decode) the EHT packet.

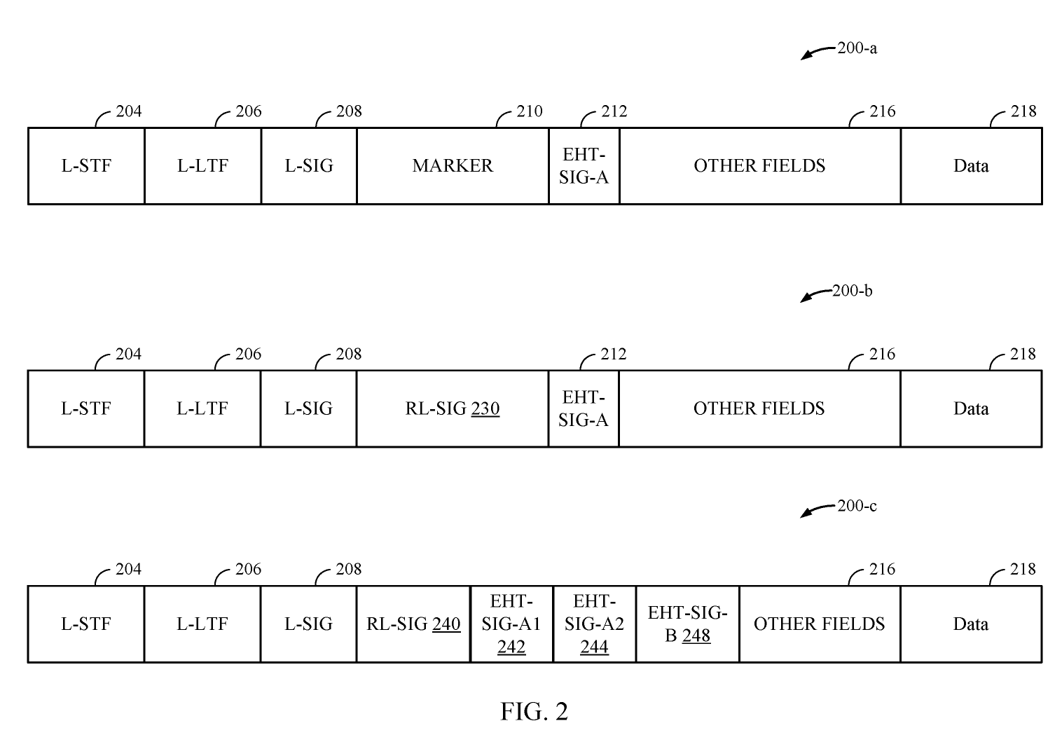

FIG. 2 illustrates an examples of EHT frames 200 that support EHT signal detection in accordance with aspects of the present disclosure. In some examples, EHT frames 200 may implement aspects of WLAN 100. EHT frames 200-a through 200-c may be configured and transmitted by an AP, and received by a STA 115, which may be examples of the corresponding devices described within. Further, EHT frames 200-a through 200-c may include legacy short training field (L-STF) 204, legacy long training field (L-LTF) 206, legacy signaling field (L-SIG) 208, other fields 216, and data 218. EHT frame 200-a may also include a marker field 210 and an EHT signal A field (EHT SIG-A). EHT frame 200-b may also include a repetition L-SIG (RL-SIG) field 230 and an EHT SIG-A field 212. EHT frame 200-c may include an RL-SIG field 240, an EHT signal A1 field (EHT SIG-A1) 242, an EHT signal A2 field (EHT SIG-A2) 244, and an EHT signal B field (EHT SIG-B) 248.

In the EHT frame 200-a the marker field 210 may be used to indicate an EHT payload. In some cases, the marker field 210 may be used to indicate the EHT frame 200-a. The marker field 210 may include an orthogonal frequency division multiplex (OFDM) symbol. Additionally or alternatively, the marker field may include a 4 us duration. In some cases, the marker field 210 may include a ½ code rate with binary phase shift keying (BPSK) modulation. Additionally or alternatively, the marker field 210 may include 24 bits of information. In some cases, a subset of the marker field bits may be configured to indicate an EHT packet. Further, any remaining bits in the marker field 210 may be configured to provide other information, such as a basic service set identifier (BSSID), etc. In some cases, the marker field 210 may be encoded with binary convolutional code (BCC). Thus, some bits of the marker field 210 may be configured for cyclic redundancy check (CRC) bits and some other bits of the marker field 210 may be configured for encoder initialization (e.g., 6 bits for a tail portion).

In the EHT frame 200-b, a masking of the RL-SIG field 230 may indicate an EHT payload. In some cases, a masked waveform of an L-SIG field in the RL-SIG field 230 may be used to indicate the EHT frame 200-b. For example, in conventional systems the RL-SIG field 230 may be transmitted as a repetition of an L-SIG field (e.g., L-SIG field 206 or 208). Providing a masking to the RL-SIG field 230 may allow for a STA receiving an L-SIG field to determine the masking of the RL-SIG field 230. For example, an L-SIG field may be configured to be transmitted with a certain waveform. The transmitting AP may configure the RL-SIG field 230 (e.g., based on knowledge that the corresponding packet is an EHT packet) to be transmitted with a masked waveform of the L-SIG field (e.g., −1*(L-SIG waveform)).

In the EHT frame 200-c, bits in the EHT-SIG-A1 field 242, the EHT-SIG-A2 field 244, the EHT-SIG-B field 248, or a combination thereof, may be configured to indicate the EHT packet. For example, any of the above mentioned fields may include reserved bits, that may be configured to carry additional information for the AP. The AP may configure at least one of these reserved bits to carry a zero value, which may indicate that this frame is an EHT frame 200-c with an EHT payload. For example, a STA may determine a high efficiency single user physical protocol data unit (HE SU PPDU) format to be an EHT SU PPDU when one of the two reserved bits in the HE SU PPDU are set to 0, (i.e., either the fourteenth bit (B14) in the HE-SIG-A1 field 242 or the HE-SIG-A2 field 244). In some cases, a STA may determine a HE extended range SU PPDU (HE ER SU PPDU) format to include an EHT ER SU PPDU when either B14 in the HE-SIG-A1 field 242 or the HE-SIG-A2 field 244 is set to 0. In some cases, a STA may determine a HE multi user PPDU (HE MU PPDU) format to include an EHT MU PPDU when a seventh bit (B7) in the HE-SIG-A2 field 244 is set to 0. In some cases, a STA may determine a HE trigger based PPDU (HE TB PPDU) format to include an EHT TB PPDU when a twenty-third bit (B23) in the HE-SIG-A1 field 242 is set to 0.

For the EHT frame 200-c, some signaling fields may be reconfigured to provide additional information for EHT communications. For example, in some cases certain fields in the EHT frame 200-c may be reconfigured to provide certain additional bits for bandwidth signaling and a number of spacetime streams (Nsts) field. In some cases, a bit from a dual subcarrier modulation (DCM) field, a Space-Time Block Coding (STBC) field, or a Coding field may be repurposed to provide an additional bit for bandwidth signaling (e.g., a bandwidth field containing 3 bits). In some of these cases, a most significant bit (MSB)/least significant bit (LSB) relation of bandwidth bits (e.g., not contiguous bits) may be configured to indicate 8 values for the bandwidth field. In some other cases, a repurposed bit for a bandwidth field may indicate a 320 MHz bandwidth. If the repurposed bit is set to zero, the repurposed bit may indicate that the ban dwidth for the EHT frame 200-c may not be a 320 MHz bandwidth PPDU, and rather the bandwidth value may be indicated by the other bits in the bandwidth field (e.g., 20, 40, 80, 160 (80+80) MHz).

Other fields may be repurposed to provide an additional one bit for Nsts signaling. For example, a DCM field, an STBC field, or a Coding field may be reconfigured to provide an additional bit for Nsts. In some cases, an MSB/LSB relation of Nsts bits (e.g., not contiguous bits) may be configured to indicate 16 values for the Nsts field. In some other cases, the Nsts field may be kept at a legacy number of bits (e.g., 3 bits) and the Nsts field may indicate only a subset of all possible Nsts values (e.g., 1, 2, 3, 4, 8, 10, 12, 16, etc.).

A HE MU PPDU may be reconfigured to accommodate a 320 MHz bandwidth signaling for EHT frame 200-c. An EHT MU PPDU format may be similar to a HE MU PPDU format (e.g., MU information may be signaled in an EHT SIG-B field or a HE SIG-B field). The EHT SIG-B field 248 may include both common information and user-specific information. However, due to a 320 MHz bandwidth, the common information field may have double the overhead for EHT frame 200-c as opposed to a legacy wireless communication frame. As such, for MU transmissions, there may be a limit of up to 8 user for a given resource unit (RU) size (e.g., a RU size greater or equal to 106 tones).

SIG-B field content channels may be duplicated to accommodate the larger bandwidth for EHT frame 200-c. For example, a 160 MHz PPDU may contain 2 SIG-B content channel, where each content channel may be duplicated 4 times. Each 20 MHz segment may include an RU allocation table of size S associated with the segment. Legacy overhead for an RU allocation table or content channel may equal 4S. For a 320 MHz PPDU containing 2 SIG-B content channels, each content channel may be duplicated 8 times. Thus, the overhead for the 320 MHz PPDU may equal 8S, thereby doubling the overhead as compared to legacy PPDU formats. Further, the 320 MHz PPDU bits may be transmitted at a lower modulation and coding scheme (MCS), thus providing for even more overhead.

A solution to the overhead issue discussed above may be to increase the number of content channels carrying the HE SIG-B fields. For example, an EHT SIG-A field may indicate the transmission includes a 320 MHz bandwidth. The corresponding HE SIG-B field may include 4 content channels following a sequential structure e.g., [1 2 3 4 1 2 3 4]). Each 20 MHz segment may include a RU allocation table of size S. Overhead for each RU allocation table/content channel may be equal to 4S. Thus, there no increase in overhead experienced by the 320 MHz PPDU format as opposed to the 160 MHz PPDU format.

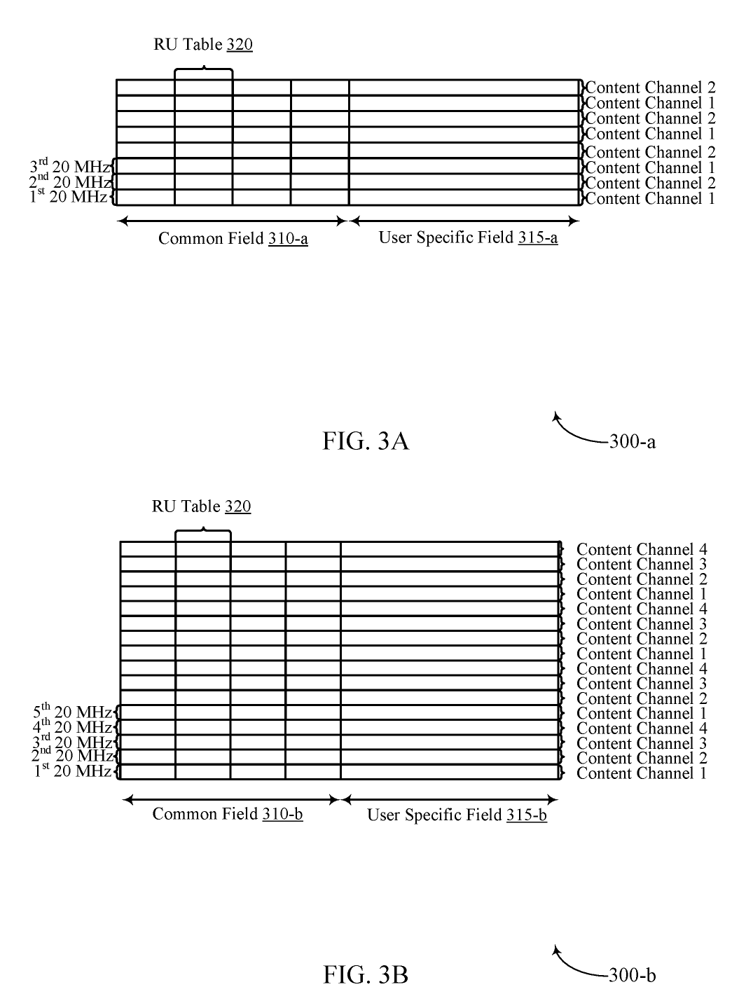

FIGS. 3A & 3B illustrate examples of content channel mappings 300-a and 300-b that support EHT signal detection in accordance with aspects of the present disclosure. In some examples, content channel mappings 300-a and 300-b may implement aspects of WLAN 100. Content channel mappings 300-a and 300-b may be configured by an AP and received by a STA, which may be examples of the corresponding devices described within.

Content channel mapping 300-a may include two HE-SIG-B content channels, content channel 1 and content channel 2. The content channels may be utilized to transmit an HE SIG-B field to a STA. The content channel mapping 300-a may follow a HE MU PPDU format, which may carry a HE wireless preamble across a 160 MHz bandwidth. The bandwidth may be partitioned into 20 MHz section, where each section is transmitted over one of the two content channels. Further, each 20 MHz section may each include a common field 310-a and a user specific field 315-a. The common field 310-a may carry information common across a set of STAs, and may include a set of RU tables 320. The user specific field 315-a may carry information specific to a certain STA. As shown, each contiguous 20 MHz section may alternate between which content channel to be transmitted over. For example, a first 20 MHz section may be carried over content channel 1, while a second 20 MHz section may be carried over content channel 2, and a third 20 MHz section may be transmitted over content channel 1. This transmission scheme may be referred to as a [1 2 1 2] pattern.

Content channel mapping 300-b may include four HE-SIG-B content channels, content channel 1, content channel 2, content channel 3, and content channel 4. The content channels may be utilized to transmit an HE SIG-B field to a STA. The content channel mapping 300-b may follow a HE MU PPDU format, which may carry a HE wireless preamble across a 320 MHz bandwidth. The bandwidth may be partitioned into 20 MHz section, where each section is transmitted over one of the two content channels. Further, each 20 MHz section may each include a common field 310-b and a user specific field 315-b. The common field 310-b may carry information common across a set of STAs, and may include a set of RU tables 320. The user specific field 315-b may carry information specific to a certain STA.

Increasing the bandwidth for transmission may also increase the overhead associated with the transmission if the same number of content channels are used. For example, if the bandwidth for transmission is increased from 160 MHz to 320 MHz, the overhead may double if two content channels are used to transmit the HE SIG-B. This overhead may cause issues for transmission, especially for HE or EHT communications. Thus, to decrease the amount of overhead associated with a 320 MHz transmission, the number of content channels may be increased. For example, as shown in content channel mapping 300-b, a 320 MHz bandwidth transmission may be transmitted over 4 content channels. Each contiguous 20 MHz section may be transmitted in a sequential order of content channels. For example, a first 20 MHz section may be carried over content channel 1, while a second 20 MHz section may be carried over content channel 2, a third 20 MHz section may be transmitted over content channel 3, a fourth 20 MHz section may be transmitted over content channel 4, and a fifth 20 MHz section may be transmitted over content channel 1. This transmission scheme may be referred to as a [1 2 3 4 1 2 3 4] pattern.

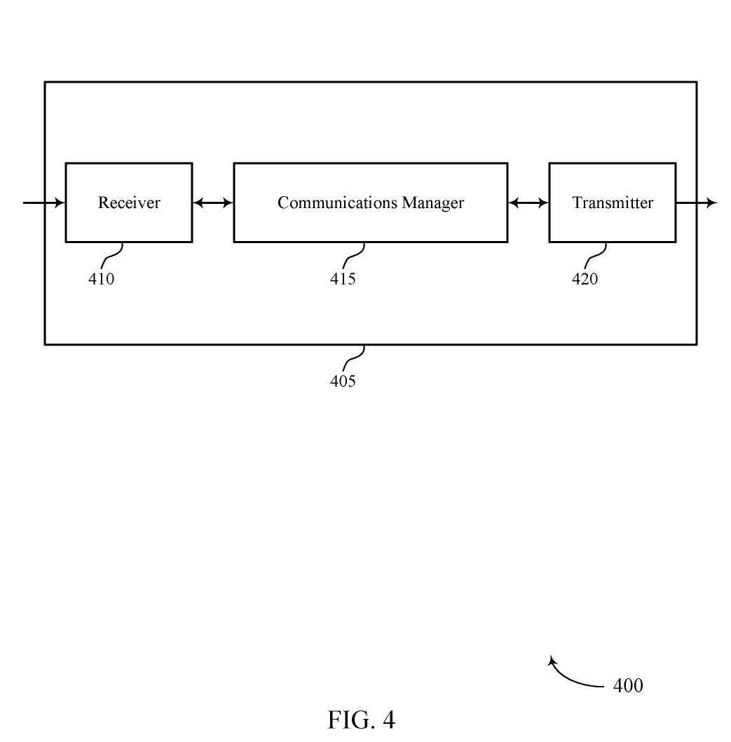

FIG. 4 shows a block diagram 400 of a device 405 that supports EHT signal detection in accordance with aspects of the present disclosure. The device 405 may be an example of aspects of a STA as described herein. The device 405 may include a receiver 410, a communications manager 415, and a transmitter 420. The device 405 may also include a processor. Each of these components may be in communication with one another (e.g., via one or more buses).

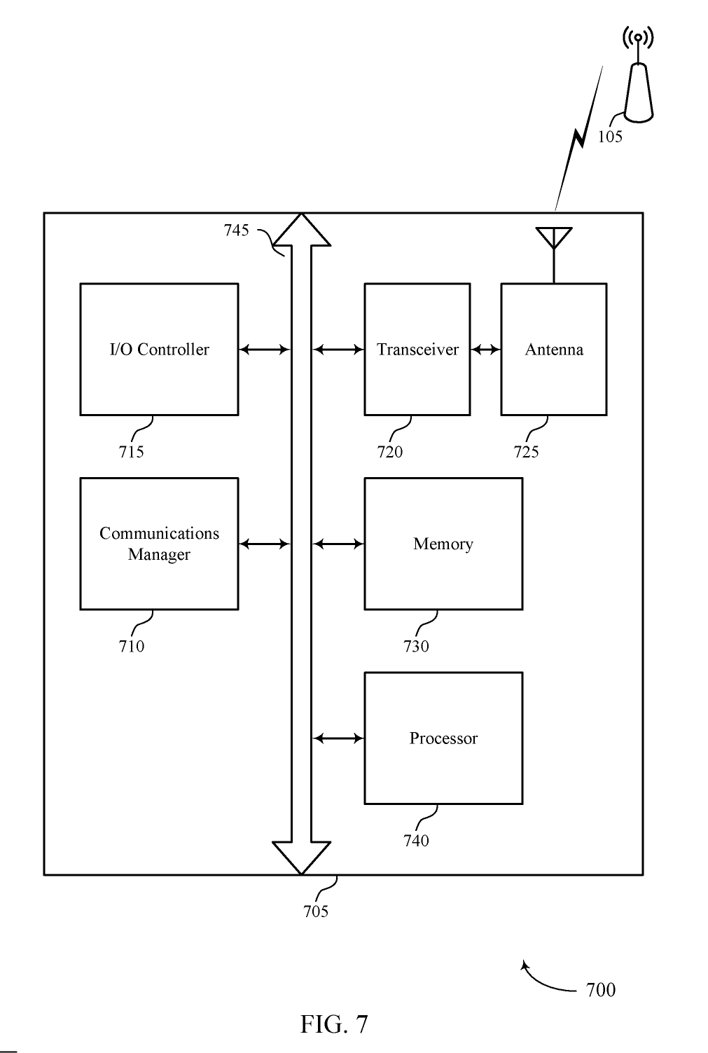

Receiver 410 may receive information such as packets, user data, or control information associated with various information channels (e.g., control channels, data channels, and information related to EHT signal detection, etc.). Information may be passed on to other components of the device. The receiver 410 may be an example of aspects of the transceiver 720 described with reference to FIG. 7. The receiver 410 may utilize a single antenna or a set of antennas.

The communications manager 415 may receive a preamble of a wireless transmission, the preamble including a legacy preamble portion and a high efficiency (HE) preamble portion. The communications manage 415 may receive the EHT packet of the wireless transmission based on the determination and according to the receive parameter. The communications manager 415 may also determine, based on a set of one or more reserved bits in a HE signaling field of the HE preamble portion, that the wireless transmission includes an EHT packet, and set, based on the determination, a receive parameter for the EHT packet of the wireless transmission. The receive parameter may include one or more of: a channel bandwidth, a spatial stream setting, or a modulation order. The communications manager 415 may also receive a preamble of a wireless transmission. The preamble may include a legacy preamble portion and a HE preamble portion. The communications manager 415 may also receive the EHT packet of the wireless transmission based on the determination and according to the receive parameter. The wireless communications manager 415 may determine the HE preamble portion is a masked version of the legacy preamble portion, and set, based on the determination, a receive parameter for the EHT packet of the wireless transmission. The receive parameter may include one or more of: a channel bandwidth, a spatial stream setting, or a modulation order. The communications manager 415 may be an example of aspects of the communications manager 710 described herein.

The communications manager 415, or its sub-components, may be implemented in hardware, code (e.g., software or firmware) executed by a processor, or any combination thereof. If implemented in code executed by a processor, the functions of the communications manager 415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 415, or its sub-components, may be physically located at various positions, including being distributed such that portions of functions are implemented at different physical locations by one or more physical components. In some examples, the communications manager 415, or its sub-components, may be a separate and distinct component in accordance with various aspects of the present disclosure. In some examples, the communications manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

Transmitter 420 may transmit signals generated by other components of the device. In some examples, the transmitter 420 may be collocated with a receiver 410 in a transceiver module. For example, the transmitter 420 may be an example of aspects of the transceiver 720 described with reference to FIG. 7. The transmitter 420 may utilize a single antenna or a set of antennas.

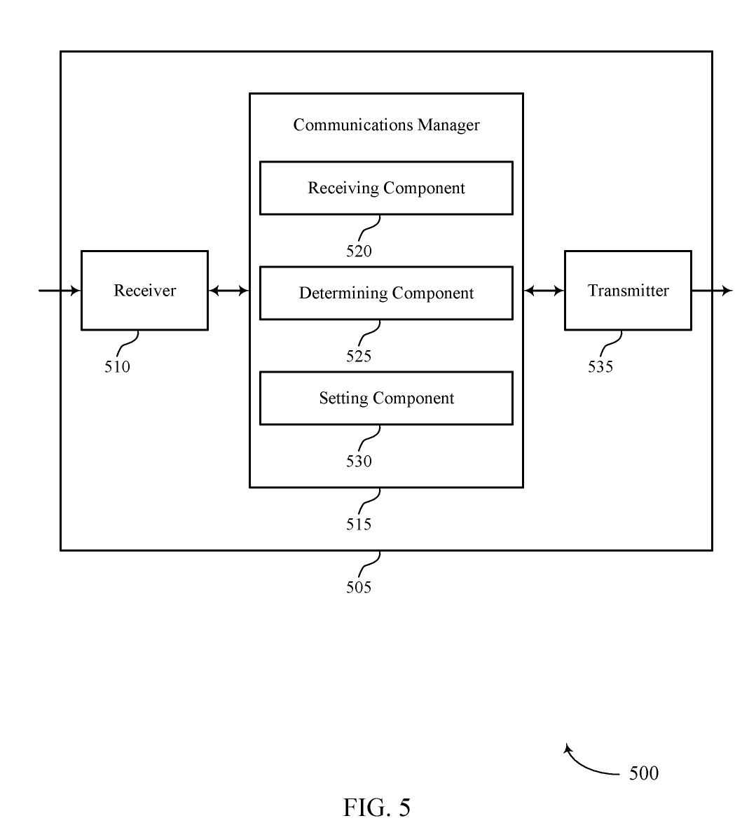

FIG. 5 shows a block diagram 500 of a device 505 that supports EHT signal detection in accordance with aspects of the present disclosure. The device 505 may be an example of aspects of a device 405 or a STA 115 as described herein. The device 505 may include a receiver 510, a communications manager 515, and a transmitter 535. The device 505 may also include one or more processors. Each of these components may be in communication with one another (e.g., via one or more buses).

Receiver 510 may receive information such as packets, user data, or control information associated with various information channels (e.g., control channels, data channels, and information related to EHT signal detection, etc.). Information may be passed on to other components of the device. The receiver 510 may be an example of aspects of the transceiver 720 described with reference to FIG. 7. The receiver 510 may utilize a single antenna or a set of antennas.

The communications manager 515 may be an example of aspects of the communications manager 415 as described herein. The communications manager 515 may include a receiving component 520, a determining component 525, and a setting component 530. The communications manager 515 may be an example of aspects of the communications manager 710 described herein.

The receiving component 520 may receive a preamble of a wireless transmission, the preamble including a legacy preamble portion and a HE preamble portion and receive the EHT packet of the wireless transmission based on the determination and according to the receive parameter.

The determining component 525 may determine, based on a set of one or more reserved bits in a HE signaling field of the HE preamble portion, that the wireless transmission includes an EHT packet.

The setting component 530 may set, based on the determination, a receive parameter for the EHT packet of the wireless transmission, the receive parameter including one or more of: a channel bandwidth, a spatial stream setting, or a modulation order.

The receiving component 520 may receive a preamble of a wireless transmission, the preamble including a legacy preamble portion and a HE preamble portion and receive the EHT packet of the wireless transmission based on the determination and according to the receive parameter.

Transmitter 535 may transmit signals generated by other components of the device. In some examples, the transmitter 535 may be collocated with a receiver 510 in a transceiver module. For example, the transmitter 535 may be an example of aspects of the transceiver 720 described with reference to FIG. 7. The transmitter 535 may utilize a single antenna or a set of antennas.

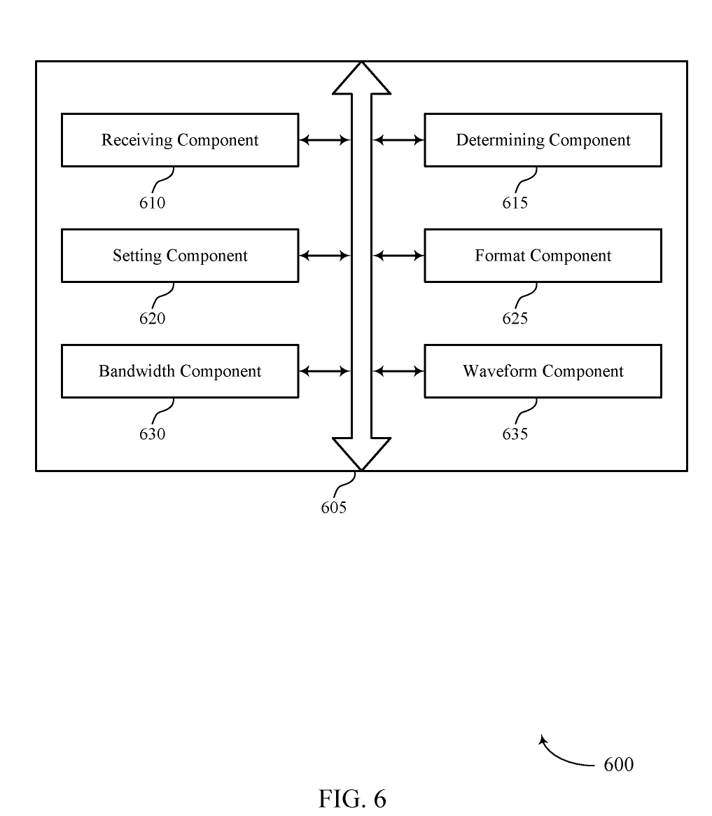

FIG. 6 shows a block diagram 600 of a communications manager 605 that supports EHT signal detection in accordance with aspects of the present disclosure. The communications manager 605 may be an example of aspects of a communications manager 415, a communications manager 515, or a communications manager 710 described herein. The communications manager 605 may include a receiving component 610, a determining component 615, a setting component 620, a format component 625, a bandwidth component 630, and a waveform component 635. Each of these modules may communicate, directly or indirectly, with one another (e.g., via one or more buses).

The receiving component 610 may receive a preamble of a wireless transmission, the preamble including a legacy preamble portion and a HE preamble portion. In some examples, the receiving component 610 may receive the EHT packet of the wireless transmission based on the determination and according to the receive parameter.

In some examples, the receiving component 610 may receive a bandwidth field in the preamble, where the bandwidth field includes at least one reconfigured bit from a dual subcarrier modulation (DCM) field, a Space-Time Block Coding (STBC) field, or a Coding field.

In some examples, the receiving component 610 may receive a Nsts field in the preamble, where the Nsts field includes at least one reconfigured bit from a dual subcarrier modulation (DCM) field, a Space-Time Block Coding (STBC) field, or a Coding field.

In some examples, the receiving component 610 may receive a HE signal A (HE SIG-A) field in the HE preamble portion. In some examples, the receiving component 610 may receive a HE signal B (HE SIG-B) field in the HE preamble portion; where the HE SIG-B field is received over 4 content channels.

In some cases, the Nsts field includes a most significant bit and a least significant bit from discontiguous portions of the preamble. In some cases, the Nsts field indicates a number of transmission streams for the wireless transmission. In some cases, the 4 content channels follow a sequential transmission structure. In some cases, the legacy preamble portion includes a legacy signaling (L-SIG) field.

The determining component 615 may determine, based on a set of one or more reserved bits in a HE signaling field of the HE preamble portion, that the wireless transmission includes an EHT packet. In some examples, the determining component 615 may determine the HE preamble portion is a masked version of the legacy preamble portion.

In some examples, the determining component 615 may determine, based on the HE SIG-A field, a bandwidth for the wireless transmission. In some cases, the bandwidth field includes a most significant bit and a least significant bit from discontiguous portions of the preamble. In some cases, the reconfigured bit indicates whether a 320 MHz bandwidth is employed for the wireless transmission.

The setting component 620 may set, based on the determination, a receive parameter for the EHT packet of the wireless transmission, the receive parameter including one or more of: a channel bandwidth, a spatial stream setting, or a modulation order.

The format component 625 may determine an EHT single user physical protocol data unit (SU PPDU) format for the EHT packet based on a value of a fourteenth bit of a SIG-A1 field or a SIG-A2 field; where receiving the EHT packet is based on the EHT SU PPDU format.

In some examples, the format component 625 may determine an EHT extended range single user physical protocol data unit (ER SU PPDU) format for the EHT packet based on a value of a fourteenth bit of a SIG-A1 field or a SIG-A2 field; where receiving the EHT packet is based on the EHT ER SU PPDU format.

In some examples, the format component 625 may determine an EHT multi user physical protocol data unit (MU PPDU) format for the EHT packet based on a value of a seventh bit of a SIG-A2 field; where receiving the EHT packet is based on the EHT MU PPDU format.

In some examples, the format component 625 may determine an EHT trigger based physical protocol data unit (TB PPDU) format for the EHT packet based on a value of a twenty third bit of a SIG-A1 field; where receiving the EHT packet is based on the EHT TB PPDU format.

The bandwidth component 630 may determine, based on the HE SIG-A field, a bandwidth for the wireless transmission. The waveform component 635 may determine a waveform for the L-SIG and a waveform for the HE preamble portion. In some examples, the waveform component 635 may identify the HE preamble portion waveform is a masked version of the L-SIG waveform. In some cases, the masked version includes an inverted version of the L-SIG waveform.

FIG. 7 shows a diagram of a system 700 including a device 705 that supports EHT signal detection in accordance with aspects of the present disclosure. The device 705 may be an example of or include the components of device 405, device 505, or a STA as described herein. The device 705 may include components for bi-directional voice and data communications including components for transmitting and receiving communications, including a communications manager 710, an I/O controller 715, a transceiver 720, an antenna 725, memory 730, and a processor 740. These components may be in electronic communication via one or more buses (e.g., bus 745).

The communications manager 710 may receive a preamble of a wireless transmission, the preamble including a legacy preamble portion and a HE preamble portion. The communications manager 710 may receive the EHT packet of the wireless transmission based on the determination and according to the receive parameter. The communications manager 710 may determine, based on a set of one or more reserved bits in a HE signaling field of the HE preamble portion, that the wireless transmission includes an EHT packet. The communications manager 710 may also set, based on the determination, a receive parameter for the EHT packet of the wireless transmission. The receive parameter may include one or more of: a channel bandwidth, a spatial stream setting, or a modulation order. The communications manager 710 may also receive a preamble of a wireless transmission, the preamble including a legacy preamble portion and a HE preamble portion. The communications manager 710 may receive the EHT packet of the wireless transmission based on the determination and according to the receive parameter. The communications manager 710 may determine the HE preamble portion is a masked version of the legacy preamble portion. The communications manager 710 may also set, based on the determination, a receive parameter for the EHT packet of the wireless transmission. The receive parameter may include one or more of: a channel bandwidth, a spatial stream setting, or a modulation order.

I/O controller 715 may manage input and output signals for device 705. I/O controller 715 may also manage peripherals not integrated into device 705. In some cases, I/O controller 715 may represent a physical connection or port to an external peripheral. In some cases, I/O controller 715 may utilize an operating system such as iOS®, ANDROID®, MS-DOS®, MS-WINDOWS®, OS/2®, UNIX®, LINUX®, or another known operating system. In other cases, I/O controller 715 may represent or interact with a modem, a keyboard, a mouse, a touchscreen, or a similar device. In some cases, I/O controller 715 may be implemented as part of a processor. In some cases, a user may interact with device 705 via I/O controller 715 or via hardware components controlled by I/O controller 715.

Transceiver 720 may communicate bi-directionally, via one or more antennas, wired, or wireless links as described above. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas.

In some cases, the wireless device may include a single antenna 725. However, in some cases the device may have more than one antenna 725, which may be capable of concurrently transmitting or receiving multiple wireless transmissions.

Memory 730 may include RAM and ROM. The memory 730 may store computer-readable, computer-executable software 735 including instructions that, when executed, cause the processor to perform various functions described herein. In some cases, the memory 730 may contain, among other things, a BIOS which may control basic hardware or software operation such as the interaction with peripheral components or devices.

Processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 740 may be configured to operate a memory array using a memory controller. In other cases, a memory controller may be integrated into processor 740. Processor 740 may be configured to execute computer-readable instructions stored in a memory to perform various functions (e.g., functions or tasks supporting EHT signal detection).

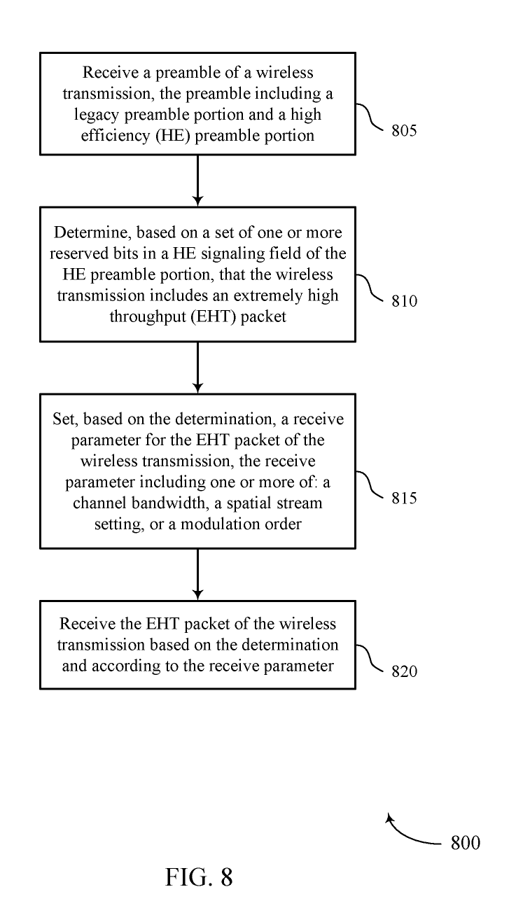

FIG. 8 shows a flowchart illustrating a method 800 that supports EHT signal detection in accordance with aspects of the present disclosure. The operations of method 800 may be implemented by a STA or its components as described herein. For example, the operations of method 800 may be performed by a communications manager as described with reference to FIGS. 4 through 7. In some examples, a STA may execute a set of instructions to control the functional elements of the STA to perform the functions described below. Additionally or alternatively, a STA may perform aspects of the functions described below using special-purpose hardware.

At 805, the STA may receive a preamble of a wireless transmission, the preamble including a legacy preamble portion and a HE preamble portion. The operations of 805 may be performed according to the methods described herein. In some examples, aspects of the operations of 805 may be performed by a receiving component as described with reference to FIGS. 4 through 7.

At 810, the STA may determine, based on a set of one or more reserved bits in a HE signaling field of the HE preamble portion, that the wireless transmission includes an EHT packet. The operations of 810 may be performed according to the methods described herein. In some examples, aspects of the operations of 810 may be performed by a determining component as described with reference to FIGS. 4 through 7.

At 815, the STA may set, based on the determination, a receive parameter for the EHT packet of the wireless transmission, the receive parameter including one or more of: a channel bandwidth, a spatial stream setting, or a modulation order. The operations of 815 may be performed according to the methods described herein. In some examples, aspects of the operations of 815 may be performed by a setting component as described with reference to FIGS. 4 through 7.

At 820, the STA may receive the EHT packet of the wireless transmission based on the determination and according to the receive parameter. The operations of 820 may be performed according to the methods described herein. In some examples, aspects of the operations of 820 may be performed by a receiving component as described with reference to FIGS. 4 through 7.

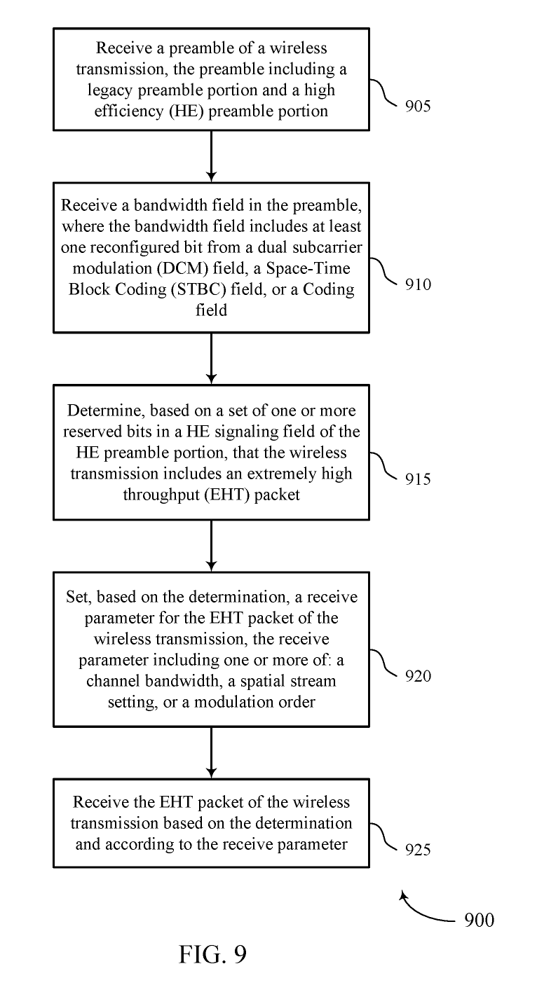

FIG. 9 shows a flowchart illustrating a method 900 that supports EHT signal detection in accordance with aspects of the present disclosure. The operations of method 900 may be implemented by a STA or its components as described herein. For example, the operations of method 900 may be performed by a communications manager as described with reference to FIGS. 4 through 7. In some examples, a STA may execute a set of instructions to control the functional elements of the STA to perform the functions described below. Additionally or alternatively, a STA may perform aspects of the functions described below using special-purpose hardware.

At 905, the STA may receive a preamble of a wireless transmission, the preamble including a legacy preamble portion and a HE preamble portion. The operations of 905 may be performed according to the methods described herein. In some examples, aspects of the operations of 905 may be performed by a receiving component as described with reference to FIGS. 4 through 7.

At 910, the STA may receive a bandwidth field in the preamble, where the bandwidth field includes at least one reconfigured bit from a dual subcarrier modulation (DCM) field, a Space-Time Block Coding (STBC) field, or a Coding field. The operations of 910 may be performed according to the methods described herein. In some examples, aspects of the operations of 910 may be performed by a receiving component as described with reference to FIGS. 4 through 7.

At 915, the STA may determine, based on a set of one or more reserved bits in a HE signaling field of the HE preamble portion, that the wireless transmission includes an EHT packet. The operations of 915 may be performed according to the methods described herein. In some examples, aspects of the operations of 915 may be performed by a determining component as described with reference to FIGS. 4 through 7.

At 920, the STA may set, based on the determination, a receive parameter for the EHT packet of the wireless transmission, the receive parameter including one or more of: a channel bandwidth, a spatial stream setting, or a modulation order. The operations of 920 may be performed according to the methods described herein. In some examples, aspects of the operations of 920 may be performed by a setting component as described with reference to FIGS. 4 through 7.

At 925, the STA may receive the EHT packet of the wireless transmission based on the determination and according to the receive parameter. The operations of 925 may be performed according to the methods described herein. In some examples, aspects of the operations of 925 may be performed by a receiving component as described with reference to FIGS. 4 through 7.

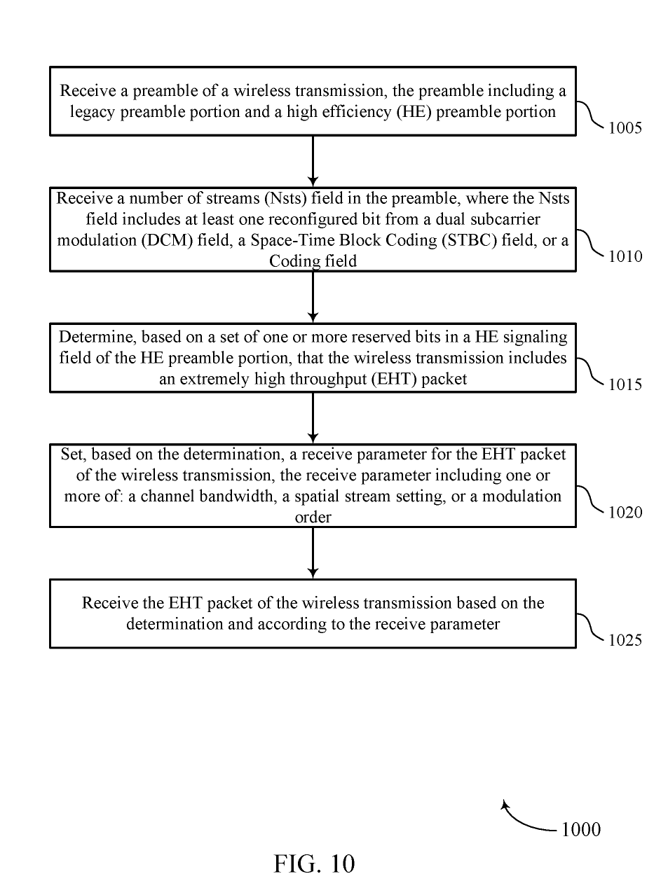

FIG. 10 shows a flowchart illustrating a method 1000 that supports EHT signal detection in accordance with aspects of the present disclosure. The operations of method 1000 may be implemented by a STA or its components as described herein. For example, the operations of method 1000 may be performed by a communications manager as described with reference to FIGS. 4 through 7. In some examples, a STA may execute a set of instructions to control the functional elements of the STA to perform the functions described below. Additionally or alternatively, a STA may perform aspects of the functions described below using special-purpose hardware.

At 1005, the STA may receive a preamble of a wireless transmission, the preamble including a legacy preamble portion and a HE preamble portion. The operations of 1005 may be performed according to the methods described herein. In some examples, aspects of the operations of 1005 may be performed by a receiving component as described with reference to FIGS. 4 through 7.

At 1010, the STA may receive a Nsts field in the preamble, where the Nsts field includes at least one reconfigured bit from a dual subcarrier modulation (DCM) field, a Space-Time Block Coding (STBC) field, or a Coding field. The operations of 1010 may be performed according to the methods described herein. In some examples, aspects of the operations of 1010 may be performed by a receiving component as described with reference to FIGS. 4 through 7.

At 1015, the STA may determine, based on a set of one or more reserved bits in a HE signaling field of the HE preamble portion, that the wireless transmission includes an EHT packet. The operations of 1015 may be performed according to the methods described herein. In some examples, aspects of the operations of 1015 may be performed by a determining component as described with reference to FIGS. 4 through 7.

At 1020, the STA may set, based on the determination, a receive parameter for the EHT packet of the wireless transmission, the receive parameter including one or more of: a channel bandwidth, a spatial stream setting, or a modulation order. The operations of 1020 may be performed according to the methods described herein. In some examples, aspects of the operations of 1020 may be performed by a setting component as described with reference to FIGS. 4 through 7.

At 1025, the STA may receive the EHT packet of the wireless transmission based on the determination and according to the receive parameter. The operations of 1025 may be performed according to the methods described herein. In some examples, aspects of the operations of 1025 may be performed by a receiving component as described with reference to FIGS. 4 through 7.

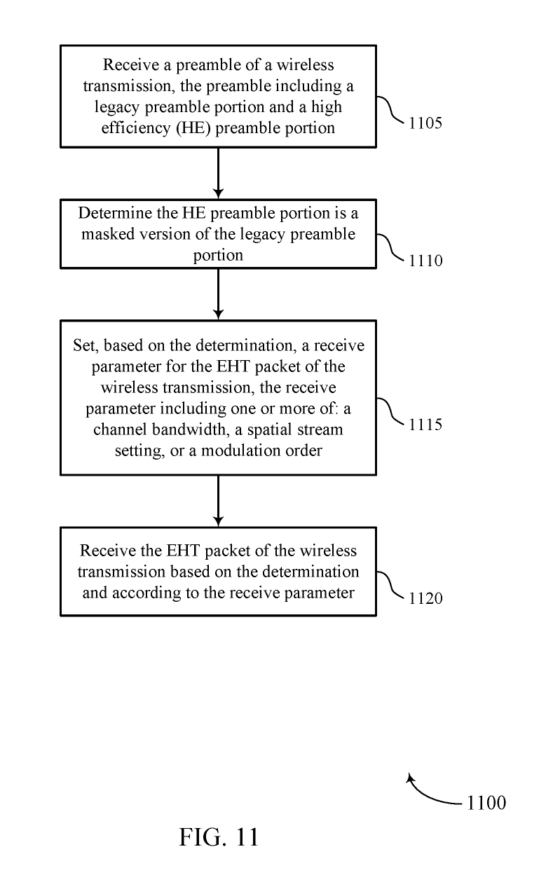

FIG. 11 shows a flowchart illustrating a method 1100 that supports EHT signal detection in accordance with aspects of the present disclosure. The operations of method 1100 may be implemented by a STA or its components as described herein. For example, the operations of method 1100 may be performed by a communications manager as described with reference to FIGS. 4 through 7. In some examples, a STA may execute a set of instructions to control the functional elements of the STA to perform the functions described below. Additionally or alternatively, a STA may perform aspects of the functions described below using special-purpose hardware.

At 1105, the STA may receive a preamble of a wireless transmission, the preamble including a legacy preamble portion and a HE preamble portion. The operations of 1105 may be performed according to the methods described herein. In some examples, aspects of the operations of 1105 may be performed by a receiving component as described with reference to FIGS. 4 through 7.

At 1110, the STA may determine the HE preamble portion is a masked version of the legacy preamble portion. The operations of 1110 may be performed according to the methods described herein. In some examples, aspects of the operations of 1110 may be performed by a determining component as described with reference to FIGS. 4 through 7.

At 1115, the STA may set, based on the determination, a receive parameter for the EHT packet of the wireless transmission, the receive parameter including one or more of: a channel bandwidth, a spatial stream setting, or a modulation order. The operations of 1115 may be performed according to the methods described herein. In some examples, aspects of the operations of 1115 may be performed by a setting component as described with reference to FIGS. 4 through 7.

At 1120, the STA may receive the EHT packet of the wireless transmission based on the determination and according to the receive parameter. The operations of Error! Reference source not found.20 may be performed according to the methods described herein. In some examples, aspects of the operations of 1120 may be performed by a receiving component as described with reference to FIGS. 4 through 7.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLAN 100 of FIG. 1—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1-20. (canceled)

21. An apparatus for wireless communications, comprising:
a processor,
memory in electronic communication with the processor; and
instructions stored in the memory and executable by the processor to cause the apparatus to:
receive a preamble of a wireless transmission, the preamble comprising a legacy preamble portion and a high efficiency (HE) preamble portion;
determine, based at least in part on a set of one or more reserved bits in a HE signaling field of the HE preamble portion, that the wireless transmission comprises an extremely high throughput (EHT) packet;
set, based at least in part on the determination, a receive parameter for the EHT packet of the wireless transmission, the receive parameter comprising one or more of: a channel bandwidth, a spatial stream setting, or a modulation order; and
receive the EHT packet of the wireless transmission based at least in part on the determination and according to the receive parameter.

22. The apparatus of claim 21, wherein the HE signaling field of the HE preamble portion comprises a HE SIG-A field.

23. The apparatus of claim 21, wherein the instructions are further executable by the processor to cause the apparatus to:
determine an EHT single user physical protocol data unit (SU PPDU) format for the EHT packet based at least in part on a value of a fourteenth bit of a SIG-A1 field or a SIG-A2 field; wherein receiving the EHT packet is based at least in part on the EHT SU PPDU format.

24. The apparatus of claim 21, wherein the instructions are further executable by the processor to cause the apparatus to:
determine an EHT extended range single user physical protocol data unit (ER SU PPDU) format for the EHT packet based at least in part on a value of a fourteenth bit of a SIG-A1 field or a SIG-A2 field; wherein receiving the EHT packet is based at least in part on the EHT ER SU PPDU format.

25. The apparatus of claim 21, wherein the instructions are further executable by the processor to cause the apparatus to:
determine an EHT multi user physical protocol data unit (MU PPDU) format for the EHT packet based at least in part on a value of a seventh bit of a SIG-A2 field; wherein receiving the EHT packet is based at least in part on the EHT MU PPDU format.

26. The apparatus of claim 21, wherein the instructions are further executable by the processor to cause the apparatus to:
determine an EHT trigger based physical protocol data unit (TB PPDU) format for the EHT packet based at least in part on a value of a twenty third bit of a SIG-A1 field; wherein receiving the EHT packet is based at least in part on the EHT TB PPDU format.

27. The apparatus of claim 21, wherein the instructions are further executable by the processor to cause the apparatus to:
receive a bandwidth field in the preamble, wherein the bandwidth field comprises at least one reconfigured bit from a dual subcarrier modulation (DCM) field, a Space-Time Block Coding (STBC) field, or a Coding field.

28. The apparatus of claim 27, wherein the bandwidth field comprises a most significant bit and a least significant bit from discontiguous portions of the preamble.

29. The apparatus of claim 27, wherein the at least one reconfigured bit indicates whether a 320 MHz bandwidth is employed for the wireless transmission.

30. The apparatus of claim 21, wherein the instructions are further executable by the processor to cause the apparatus to:
receive a number of streams (Nsts) field in the preamble, wherein the Nsts field comprises at least one reconfigured bit from a dual subcarrier modulation (DCM) field, a Space-Time Block Coding (STBC) field, or a Coding field.

31. The apparatus of claim 30, wherein the Nsts field comprises a most significant bit and a least significant bit from discontiguous portions of the preamble.

32. The apparatus of claim 30, wherein the Nsts field indicates a number of transmission streams for the wireless transmission.

33. The apparatus of claim 21, wherein the instructions are further executable by the processor to cause the apparatus to:
receive a HE signal A (HE SIG-A) field in the HE preamble portion;
determine, based on the HE SIG-A field, a bandwidth for the wireless transmission; and
receive a HE signal B (HE SIG-B) field in the HE preamble portion; wherein the HE SIG-B field is received over 4 content channels.

34. The apparatus of claim 33, wherein the 4 content channels follow a sequential transmission structure.

35. An apparatus for wireless communications, comprising:
a processor,
memory in electronic communication with the processor; and
instructions stored in the memory and executable by the processor to cause the apparatus to:
receive a preamble of a wireless transmission, the preamble comprising a legacy preamble portion and a high efficiency (HE) preamble portion;
determine the HE preamble portion is a masked version of the legacy preamble portion;
set, based at least in part on the determination, a receive parameter for an extremely high throughput (EHT) packet of the wireless transmission, the receive parameter comprising one or more of: a channel bandwidth, a spatial stream setting, or a modulation order; and
receive the EHT packet of the wireless transmission based at least in part on the determination and according to the receive parameter.

36. The apparatus of claim 35, wherein the legacy preamble portion comprises a legacy signaling (L-SIG) field.

37. The apparatus of claim 36, wherein the instructions are further executable by the processor to cause the apparatus to:
determine a first waveform for the L-SIG field and a second waveform for the HE preamble portion; and
identify the second waveform is a masked version of the first waveform.

38. The apparatus of claim 37, wherein the masked version comprises an inverted version of the first waveform.

39. The apparatus of claim 35, wherein the instructions are further executable by the processor to cause the apparatus to:
receive a HE signal A (HE SIG-A) field in the HE preamble portion;
determine, based on the HE SIG-A field, a bandwidth for the wireless transmission; and
receive a HE signal B (HE SIG-B) field in the HE preamble portion; wherein the HE SIG-B field is received over 4 content channels.

40. The apparatus of claim 39, wherein the 4 content channels follow a sequential transmission structure.

41-42. (canceled)

43. A non-transitory computer-readable medium storing code for wireless communications, the code comprising instructions executable by a processor to:
receive a preamble of a wireless transmission, the preamble comprising a legacy preamble portion and a high efficiency (HE) preamble portion;
determine, based at least in part on a set of one or more reserved bits in a HE signaling field of the HE preamble portion, that the wireless transmission comprises an extremely high throughput (EHT) packet;
set, based at least in part on the determination, a receive parameter for the EHT packet of the wireless transmission, the receive parameter comprising one or more of: a channel bandwidth, a spatial stream setting, or a modulation order; and
receive the EHT packet of the wireless transmission based at least in part on the determination and according to the receive parameter.

44. A non-transitory computer-readable medium storing code for wireless communications, the code comprising instructions executable by a processor to:
receive a preamble of a wireless transmission, the preamble comprising a legacy preamble portion and a high efficiency (HE) preamble portion;
determine the HE preamble portion is a masked version of the legacy preamble portion;
set, based at least in part on the determination, a receive parameter for an extremely high throughput (EHT) packet of the wireless transmission, the receive parameter comprising one or more of: a channel bandwidth, a spatial stream setting, or a modulation order; and
receive the EHT packet of the wireless transmission based at least in part on the determination and according to the receive parameter.
